(19) United States
(12) Patent Application Publication
(10) Pub. No.: US 2007/0108280 A1
(43) Pub. Date: May 17, 2007

(54) MEMORY CARD AND TERMINAL EQUIPMENT INCORPORATING THE SAME

(75) Inventors: JIN LI, Shenzhen (CN); Fang Yang, Shenzhen (CN)

Correspondence Address: FULBRIGHT & JAWORSKI L.L.P., 600 CONGRESS AVE., SUITE 2400, AUSTIN, TX, 78701, US

(73) Assignee: Huawei Technologies Co., LTD., Shenzhen (CN)

(21) Appl. No.: 11/554,416

(22) Filed: Oct. 30, 2006

(30) Foreign Application Priority Data
Oct. 31, 2005 (CN) 2005 10100762.X

(51) Int. Cl. G06K 7/08; G06K 19/06

(52) U.S. Cl. 235/451; 235/492

(57) ABSTRACT

Embodiments of the invention provide a memory card with RFID function, which includes a memory unit and a memory card interface for exchanging data stored in the memory unit with external equipment, wherein the data stored in the memory unit includes RFID configuration information, the memory card further includes: an RFID function unit, which configures itself with the RFID configuration information stored in the memory unit and identifies received radio frequency signals. Furthermore, the invention provides a terminal equipment incorporating the memory card. Embodiments of the invention can extend a terminal equipment to include RFID function through the memory card at lower cost and better compatibility, so as to meet market demand.

### FIELD OF THE INVENTION

The invention relates to a radio frequency identification (RFID) equipment. More particularly, the invention relates to a terminal equipment with radio frequency identification function.

### BACKGROUND OF THE INVENTION

Radio Frequency Identification (RFID), commonly referred to as Electronic Tag, is a technique that utilizes spatial coupling (alternating magnetic field or electromagnetic field) of radio frequency signals to implement contactless information transmission and attain identification purpose with the transmitted information.

As shown in FIG. 1, a radio frequency identification system generally includes three parts:

a tag, which includes a coupling component and a chipset, has a respective unique electronic code and is attached to an object for identifying the object;

a reader, which is a device that reads (and writes in some cases) tag information and can be designed as a handheld type or a fixed type; and

a transmission medium,such as electromagnetic wave,which is used to transmit radio frequency signals between the tag and the reader.

When the tag enters into the transmission medium (e.g., magnetic field), product information stored on the tag (Passive Tag) is sent out by means of the energy obtained from an induced current, or the tag (Active Tag) sends signals at a certain frequency on its own initiative; the reader reads the information from the tag, decodes the information, and then sends the information to a central information system for relevant data processing. As an automatic contactless identification technique, RFID does not need manual intervention and has advantages that are not available in bar code technique, e.g., waterproofing, magnetic resistance, high temperature resistance, long service life, long reading distance, encrypted tag data, high data storage capacity, free modification of stored information, etc. Therefore, RFID technique has been used in many fields today, such as materials circulation and supply management, airline luggage handling, mail/express package handling, access control/electronic ticket, etc.

Existing terminal equipment can be extended to include RFID function. A mobile communication terminal with RFID function is disclosed in US patent application Publication No. 20050088285 entitled “Mobile communication terminal with RFID function and RFID programming method in the Same” and filed on Oct. 28, 2003 by Samsung, Korea; the technical solution disclosed therein is a mobile communication terminal including: a radio frequency identification (RFID) receiver for receiving RFID data in a first format; an operation device for converting the RFID data in the first format into a second format; a memory for storing the RFID data in the second format; a codec for encoding the RFID data stored in the memory; a modulator for RFID-modulating the encoded data output from the codec; and an RFID transmitter for transmitting the modulated data output from the modulator to an RFID reader.

### SUMMARY OF THE INVENTION

An embodiment of the present invention is to provide a memory card with RFID function and a terminal equipment incorporating the memory card.

A memory card is provided according to an embodiment of the invention, which includes a memory unit and a memory card interface for exchanging data stored in the memory unit with external equipment, wherein the data stored in the memory unit includes RFID configuration information. The memory card further includes:

an RFID function unit, which configures itself with the RFID configuration information stored in the memory unit and identifies received radio frequency signals.

Correspondingly, a terminal equipment incorporating a memory card is provided according to an embodiment of the invention, the memory card includes a memory unit and a memory card interface for exchanging data stored in the memory unit with the terminal equipment, wherein the data stored in the memory unit includes RFID configuration information, the memory card further includes:

an RFID function unit, which is connected to the memory unit and configures itself with the RFID configuration information stored in the memory unit and identifies received RFID signals.

Compared to the prior art, the invention may have the following benefits:

Firstly, the invention indirectly extends a handheld device to include RFID function through a memory card. If a user wants to add RFID function to his/her own handheld device, the user only needs to buy a memory card with RFID function as described in the invention and insert the memory card into the handheld device without having to buy a new handheld device. Therefore, the user's purchase cost is reduced greatly.

Secondly, the memory card can be replaced freely, so that the user may make his/her own handheld device compatible to any handheld device conforming to RFID protocol, and the invention may also expand RFID application domain to all handheld terminal products with a memory card interface. As long as the handheld device has the memory card interface, the user may extend the handheld device to include RFID function very conveniently by using the memory card with RFID function as described in the invention.

### BRIEF DESCRIPTION OF THE DRAWINGS

FIG. 1 is a schematic diagram of construction of an RFID system in the prior art;

FIG. 2 is a schematic diagram of internal structure of a memory card according to an embodiment of the invention;

FIG. 3 is a schematic diagram of operating system software hierarchy of a handheld device according to an embodiment of the invention;

FIG. 4 is a flowchart of RFID signal processing in a handheld device according to an embodiment of the invention.

### DETAILED DESCRIPTION OF THE PREFERRED EMBODIMENTS

As communication technology develops, memory cards are used increasingly in handheld devices such as digital cameras, intelligent mobile telephones, MP3 devices, PDAs, and DVs, etc. Handheld devices can be extended to include new functions by embedding some modules with specific functions in memory cards and then combining the memory cards with the specific functions with the handheld devices.

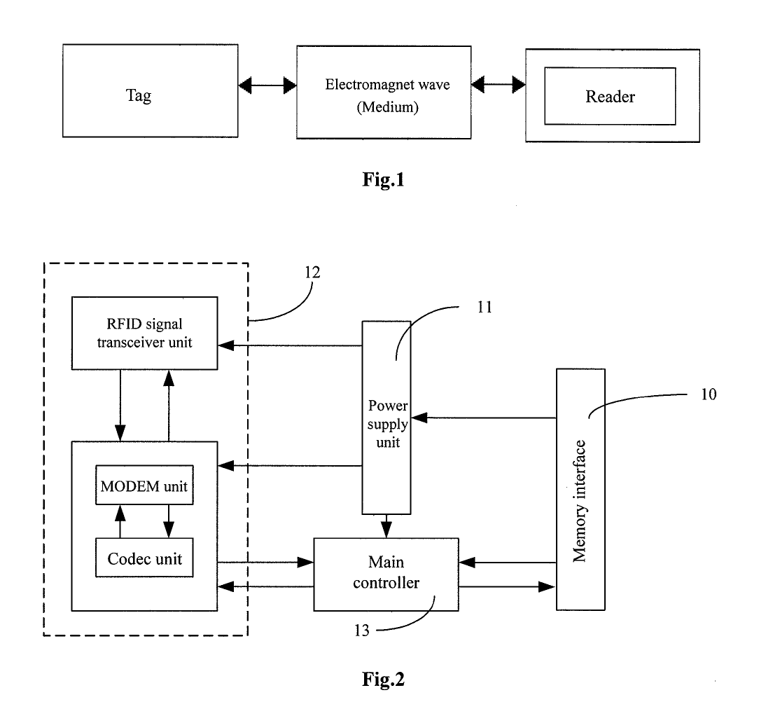

FIG. 2 is a schematic diagram of internal structure of a memory card according to an embodiment of the invention. A main controller 13 serves as a control unit of the memory card, and has a certain storage space which can be used as a memory unit to store information. In the embodiment of the invention, the information stored in the main controller 13 mainly includes memory card configuration information, RFID protocol, RFID data, and other RFID configuration information required in RFID communication process. Different RFID protocols can be loaded in the main controller 13 as required, so as to sufficiently solve the problem of poor RFID compatibility between different products. Of course, it is also possible to store the above information in a memory unit outside the main controller 13 in accordance with memory configuration of the main controller 13. The memory card is connected to external equipment via a memory card interface 10; a power supply unit 11 obtains power from the memory card interface 10 and supply power to other circuits in the memory card. The memory card according to the embodiment has an RFID function unit 12, which configures itself with the RFID configuration information stored in the memory unit and identifies received radio frequency signals. The RFID function unit 12 can be an RFID card reader unit or an RFID inductor unit. As an embodiment of the present invention shown in FIG. 2, when the RFID unit 12 is an RFID card reader function unit, it includes:

a codec unit for encoding/decoding RFID data in accordance with card reading function as specified in RFID protocol;

a MODEM unit for modulating the RFID data into corresponding RFID signals or demodulating RFID signals into corresponding RFID data;

an RFID signal transceiver unit for sending/receiving the RFID signals to/from the MODEM unit.

Likewise, in another embodiment of the invention, if the RFID unit is an RFID inductor function unit, the RFID inductor function unit may also employ the following structure:

a codec unit (not shown) for encoding/decoding RFID data in accordance with induction function as specified in RFID protocol;

a MODEM unit (not shown) for modulating the RFID data into corresponding RFID signals or demodulating RFID signals into corresponding RFID data;

an RFID signal transceiver unit (not shown) for sending/receiving the RFID signals to/from the MODEM unit.

It should be noted that in particular embodiments, the RFID signal transceiver unit may be a coupling antenna usually in coil form. In addition, the RFID signal transceiver unit may be any device that can implement RFID signal sending/receiving function. Therefore, it is not described in detail here.

In the embodiment of the invention, the main controller 13 may receive or send relevant information in RFID communication process via the memory card interface 10. If the main controller 13 receives information from other devices, the received information is sent to the codec unit by the main controller 13, and then encoded in accordance with the RFID protocol loaded in the main controller 13 by the codec unit. After the information is modulated, it is sent out by the RFID signal transceiver unit. On the other hand, when an RFID signal is received by the RFID signal transceiver unit, the signal is demodulated by the MODEM unit and then decoded in accordance with the RFID protocol loaded in the main controller 13 by the codec unit. Then, the decoded signal is sent to the memory card interface to be received by the handheld device. As described above, the memory card may be connected to any other handheld terminal via the memory card interface 10, as long as the handheld terminal has an interface to accommodate the memory card. The handheld device may perform read/write control for the memory card by installing a driver for the memory card in the operating system(OS) of the handheld device.

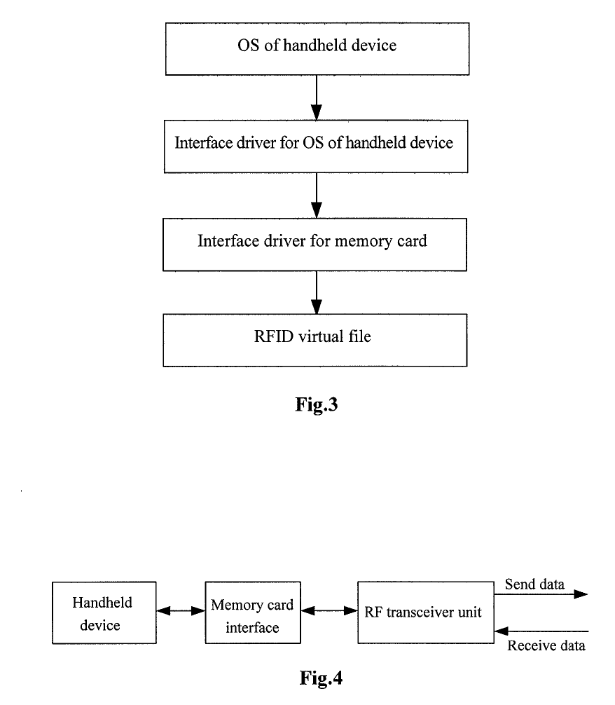

A handheld device is provided in an embodiment of the present invention. The following explanation will be made in connection with a particular application of the handheld device. FIG. 3 is a schematic diagram of OS software hierarchy of the handheld device according to an embodiment of the invention. As seen from FIG. 3, the OS of the handheld device includes an interface driver for the handheld device, while an interface driver for the memory card is below the interface driver for the handheld device. Therefore, the OS of the handheld device ensures that the handheld device can operate the memory card inserted therein, including reading the data stored in the memory card and writing the data in the handheld device into the memory card. And the handheld device can read or write the files derived from RFID information. In that case, from the viewpoint of the handheld device, the memory card inserted in the handheld device is equivalent to an accessible space mapped to the file system of the handheld device, and the handheld device can perform read/write operation for the memory card through the driver on its OS. As seen from FIG. 3, an RFID virtual file is below the interface driver for the memory card. Through the RFID virtual file, the handheld device can access and configure the RFID unit in the memory card. Due to the handheld device's configuration capability for the RFID unit, the RFID data in the memory card is no longer unchangeable but can be updated in real time.

The OS shown in FIG. 3 mainly operates on the memory card shown in FIG. 2. With respect to actual implementation of the handheld device and associated memory card format, the OS of the handheld device has already included the driver for the memory card in itself. The memory card driver interface shields characteristics of the memory card to the OS interface of handheld device on its upper layer, and thereby implements transparent access to the memory card. The software portion can be implemented by the handheld device developer during the software development process, and compatibility can be taken into consideration at that time. Therefore, it can support the memory card in the handheld device. For the OS of the handheld device, the memory card is a part of its software files. Thereby, the access to the memory card is just the access to the memory card file. And the handheld device can read or write the files derived from RFID information. In this way, the work of programming a software driver and an application interface for each host software system separately is avoided.

FIG. 4 is a flowchart of RFID signal processing in the handheld device according to an embodiment of the invention. The handheld device may be extended to include RFID function by controlling the memory card interface. RFID signals are transmitted into the handheld device via the RFID transceiver unit of the memory card and the memory card interface. The data processed in the handheld device is returned in the original path, and finally sent out by the RFID transceiver unit. In this way, the entire process of RFID function is accomplished in the handheld device.

The above description is only preferred embodiments of the invention. It should be noted that those skilled in the art can make improvements and embellishments to the embodiments without departing from the principle of the invention. Such improvements or embellishments should be considered as falling into the scope of the invention.

What is claimed is:

1. A memory card, comprising a memory unit and a memory card interface for exchanging data stored in the memory unit with external equipment, wherein the data stored in the memory unit comprises RFID configuration information, the memory card further comprises:
an RFID function unit, which configures itself with the RFID configuration information stored in the memory unit and identifies received radio frequency signals.

2. The memory card according to claim 1, wherein the RFID function unit is an RFID card reader unit.

3. The memory card according to claim 2, wherein the RFID card reader unit comprises:
a codec unit for encoding/decoding RFID data in accordance with card reading function as specified in RFID protocol;
a MODEM unit for modulating the RFID data into corresponding RFID signals or demodulating RFID signals into corresponding RFID data;
an RFID signal transceiver unit for sending/receiving the RFID signals to/from the MODEM unit.

4. The memory card according to claim 3, wherein the RFID signal transceiver unit is a coupling antenna.

5. The memory card according to claim 1, wherein the RFID function unit is an RFID inductor unit.

6. The memory card according to claim 5, wherein the RFID inductor unit comprises:
a codec unit for encoding/decoding RFID data in accordance with induction function as specified in RFID protocol;
a MODEM unit for modulating the RFID data into corresponding RFID signals or demodulating RFID signals into corresponding RFID data;
an RFID signal transceiver unit for sending/receiving the RFID signals to/from the MODEM unit.

7. The memory card according to claim 1, wherein the RFID configuration information is RFID configuration information in diverse RFID protocols.

8. A terminal equipment incorporating a memory card which comprises a memory unit and a memory card interface for exchanging data stored in the memory unit with the terminal equipment, wherein the data stored in the memory unit comprises RFID configuration information, the memory card further comprises:
an RFID function unit, which configures itself with the RFID configuration information stored in the memory unit and identifies received radio frequency signals.

9. The terminal equipment incorporating the memory card according to claim 8, wherein the RFID function unit is an RFID card reader unit.

10. The terminal equipment incorporating the memory card according to claim 9, wherein the RFID card reader unit comprises:
a codec unit for encoding/decoding RFID data in accordance with card reading function as specified in RFID protocol;
a MODEM unit for modulating the RFID data into corresponding RFID signals or demodulating RFID signals into corresponding RFID data;
an RFID signal transceiver unit for sending/receiving the RFID signals to/from the MODEM unit.

11. The terminal equipment incorporating the memory card according to claim 10, wherein the RFID transceiver unit is a coupling antenna.

12. The terminal equipment incorporating the memory card according to claim 8, wherein the RFID function unit is an RFID inductor unit.

13. The terminal equipment incorporating the memory card according to claim 12, wherein the RFID inductor unit comprises:
a codec unit for encoding/decoding RFID data in accordance with induction function as specified in RFID protocol;
a MODEM unit for modulating the RFID data into corresponding RFID signals or demodulating RFID signals into corresponding RFID data;
an RFID signal transceiver unit for sending/receiving the RFID signals to/from the MODEM unit.

14. The terminal equipment incorporating the memory card according to claim 8, wherein the terminal equipment is a handheld terminal equipment with an external memory card interface.

15. The terminal equipment incorporating the memory card according to claim 14, wherein the handheld terminal equipment with the external memory card interface is a mobile telephone, digital camera, MP3 device, PDA, or DV.

16. The terminal equipment incorporating the memory card according to claim 8, wherein the RFID configuration information is RFID configuration information in diverse RFID protocols.

17. A terminal equipment for operating a memory card with an RFID function according to RFID configuration information stored in the memory card, the terminal equipment comprising an interface for receiving the memory card, and a controller unit for accessing data stored in the memory card via the interface, and reading or writing the data derived from RFID information.

18. The terminal equipment according to claim 17, wherein, the controller unit holds the memory card as an accessible space mapped to the file system of the terminal equipment, and performs read/write operation for the memory card via the interface.

19. The terminal equipment according to claim 18, wherein, the controller unit reads or writes the data stored in the memory card derived from RFID information as an RFID file.

20. The terminal equipment according to claim 18, wherein, the controller unit updates RFID configuration information in the memory card to update the RFID protocol of the memory card.
